(19) United States
(12) Patent Application Publication
(10) Pub. No.: US 2025/0117623 A1
(43) Pub. Date: Apr. 10, 2025

(54) Multi-tiered Machine Learning Modeling Framework for Digital Component Provision to Endpoints

(71) Applicant: The Toronto-Dominion Bank, Toronto (CA)

(72) Inventors: Bharathvaj Devarajan, Ontario (CA); Sagar Purkayasth, Calgary (CA); Wenjia Zhu, Vancouver (CA)

(21) Appl. No.: 18/481,001

(22) Filed: Oct. 4, 2023

(51) Int. Cl. G06N 3/045; G06N 3/091; G06Q 30/0204

(52) U.S. Cl. CPC G06N 3/045; G06N 3/091; G06Q 30/0204

(57) ABSTRACT

An example method includes receiving a set of features representing attributes for a user and receiving data for multiple digital campaigns. The set of features can be processed using a propensity machine learning model to determine whether the first user is expected to perform an affirmative action in response to the digital campaign. A subset of contributing features that are indicative of a likelihood of the first user performing the affirmative action can be generated using a feature importance model for each digital campaign. For each digital campaign, a respective output indicating a likelihood that the first user will perform an affirmative action in response to the respective digital campaign can be obtained using a respective trained student-teacher neural network. These outputs can be compared to identify a particular digital campaign and one or more digital components associated with this campaign can be transmitted to the first user.

### TECHNICAL FIELD

The present disclosure relates to computer-implemented methods, software, and systems for using multiple phases of machine learning models for identifying and providing digital campaigns for users of a digital platform.

### BACKGROUND

Various digital and electronic platforms have users that use different services and functions of the platform. For a particular platform, there may be different levels or user/entity categories for the platform. A digital campaign may be selected to be transmitted to users of a digital platform in order to prompt the user to transition from one user category to another user category. As used in this specification, a digital campaign indicates one or more digital components to send to client device that are intended recipients of the digital campaign.

Conventional campaign selection systems generally employ a random approach to determine which of several digital campaigns are transmitted to a user/client device. A system may have multiple different digital campaigns to transmit to one or more user devices, and can select a digital campaign at random to transmit to one or more such user devices (associated with users of the digital platform).

### SUMMARY

The present disclosure generally relates to systems, software, and computer-implemented methods for using multiple phases of machine learning models for identifying and providing digital campaigns for users of a digital platform

A first example method includes receiving a set of features representing attributes corresponding to a first user and receiving data for a plurality of digital campaigns, wherein data for each digital campaign in the plurality of digital campaigns indicates one or more digital components to send to users receiving that campaign. The set of features can be processed using a propensity machine learning model to determine whether the first user is expected to perform an affirmative action in response to the digital campaign, wherein the affirmative action includes performing one or more operations to transition from a first user category to a second user category on a digital platform. A subset of contributing features for the user that are indicative of a likelihood of the first user performing the affirmative action in response to the digital campaign can be generated using a feature importance model for each digital campaign in the plurality of digital campaigns. For each digital campaign, a respective set of network inputs corresponding to the digital campaign can be generated, wherein each network input represents a user feature related to a particular digital campaign, by processing the respective subset of contributing feature. For each digital campaign in the plurality of digital campaigns, a respective output indicating a likelihood that the first user will perform an affirmative action in response to the respective digital campaign can be obtained by processing each set of network inputs using a respective trained student-teacher neural network. The outputs from the trained student-teacher neural networks can be compared to identify a particular digital campaign in response to which the first user has a highest likelihood of performing the affirmative action. One or more digital components associated with the particular digital campaign can be transmitted to the first user.

Implementations can optionally include one or more of the following features.

In some implementations, the method can also include training each student-teacher neural network model by receiving a set of unlabeled training data from the feature importance model and receiving, for a first set of unlabeled training data, a set of respective labels, wherein each label is associated with a contributing feature for the user that is indicative of a likelihood that the first user will respond affirmatively to the respective digital campaign. The first set of unlabeled training data that is associated with the received set of labels and a second set of unlabeled training data can be processed to generate a set of network inputs, wherein each network input represents a contributing feature for the user. The set of network inputs can be processed using a trained teacher neural network of the student-teacher neural network that generates a respective initial output for each network input. A student neural network of the student-teacher neural network can be trained to optimize a loss function, wherein the student neural network processes the set of network inputs and generates a respective output for each network input. In some examples, training a student neural network of the student-teacher neural network to optimize a loss function comprises, for each contributing feature for the user includes minimizing a loss term that measures a difference between the initial output of the teacher neural network and a proposed output of the student neural network when the set of respective labels does not include a label associated with the contributing feature and minimizing a loss term that measures a difference between the proposed output of the student neural network and the label associated with the contributing feature when the set of respective labels includes a label associated with the contributing feature. In some examples the loss term that measures a difference between the initial output of the teacher neural network and the proposed output of the student neural network is a mean squared error. In some examples the loss term that measures a difference between the proposed output of the student neural network and the label associated with the contributing feature is a cross-entropy loss. In some instances, the student neural network and the teacher neural network have a same architecture.

In some implementations, the propensity model is a gradient boosting model.

In some implementations, the feature importance model is a gradient boosting model.

In some implementations, each trained student-teacher neural network is trained using an active learning technique.

In some implementations, the subset of contributing features comprises the set of features.

Similar operations and processes associated with each example system may be performed in a different system comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. Additionally, similar operations can be associated with or provided as computer-implemented software embodied on tangible, non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

The techniques described herein can be implemented to achieve the following advantages. For example, the techniques described herein implement feature importance models (that are implemented as machine learning models) that reduce the number of features that are used to generate inputs for the student-teacher networks, which then allows the student-teacher networks of the overall model architecture described herein to be lightweight (as a result of the reduction of core features for each digital campaign). In this manner, the model's ultimate computation (as described throughout this specification) is performed with respect to a substantially reduced feature set instead of a larger population of features—without any substantive impact on the solution's overall accuracy.

In this manner, the techniques described herein enable a campaign selection system to use an active learning framework to generate a likelihood that a user will respond affirmatively to a particular digital campaign by implementing resource efficient techniques to utilize a subset of labelled training examples during training of a student-teacher neural network. In general, training student-teacher neural network with only unlabeled data can be a computing resource intensive task. In contrast, the techniques described herein utilize unlabeled data as well as labelled data to identify those features that have a high contribution (or are expected to have a high contribution) to the student-teacher network's output. Unlike conventional solutions that do not have enough training data to converge in a timely and resource efficient manner, the techniques described herein achieve relative computation efficiencies by also providing the student-teacher network with labelled data points using an adaptive learning framework-which in turn would converge sooner (and as a result, in a more efficient manner that reduces computing resources consumed toward convergence). This allows for less time spent training because, instead of using random initialization, training data can be initialized using the labelled data.

Moreover, the improved campaign selection techniques described herein further result in greater computing resource efficiencies. The techniques described herein enable a digital campaign selection system to only transmit digital campaigns that have a high likelihood of being interacted with, and in that regard, also achieve computing and network resource efficiencies stemming from reduce resource usage in identifying suitable digital campaigns to deliver over the network to a host of user devices.

### DESCRIPTION OF DRAWINGS

FIG. 1 is a block diagram of an example networked environment for using multiple phases of machine learning models for identifying and providing digital campaigns for users of a digital platform.

FIG. 2 illustrates an example campaign selection system that is configured to use multiple machine learning models to identify and providing digital campaigns for a user in a networked environment, such as the networked environment 100.

FIG. 3 is a flow diagram of an example method for identifying a digital campaign for a user.

FIG. 4 is a flow diagram of an example method for training a student-teacher neural network to identify a likelihood that a user will respond affirmatively to a digital campaign.

### DETAILED DESCRIPTION

The present disclosure describes various tools and techniques associated with using multiple phases of machine learning models for identifying and providing digital campaigns to user devices associated with users of a digital platform.

Conventional digital campaign selection systems generally employ a random approach to determining which of several digital campaigns are transmitted to one or more user devices. However, the random approach suffers from multiple deficiencies. As an initial matter, this approach may waste computing and network resources on sending digital campaigns that are unlikely to be interacted with.

In contrast, the techniques described herein enable increased computational and network resource efficiency by enabling a digital campaign selection system to transmit digital campaigns that have a high likelihood of being interacted with. In some implementations, the techniques described herein implement a digital campaign selection system that can determine if a particular user is expected to transition to a particular user category on a digital platform in response to a digital campaign and which of several candidate digital campaigns is expected to result in an affirmative action from a user (e.g., a positive interaction with a campaign's digital component(s) that leads to user transitioning from one user category to another).

At a high level, the techniques described here uses multiple machine learning models to (1) compute if a user is expected to transition to a particular user category on a digital platform in response to a digital campaign, (2) generate a subset of contributing features for the user that are indicative of a likelihood of the user interacting with (e.g., responding to) the digital campaign for each candidate digital campaign, and (3) generate a likelihood that the user will respond affirmatively to each respective digital campaign. The models' output of the likelihood that the user will respond affirmatively to each respective digital campaign for each digital campaign is compared, and the digital campaign with the highest output likelihood is selected and the digital components associated with that campaign are then transmitted to the user.

Additionally, the above-described campaign selection system can use an active learning framework to generate a likelihood that a user will respond affirmatively to a particular digital campaign by implementing resource efficient techniques to utilize a subset of labelled training examples during training of a student-teacher neural network. In general, training student-teacher neural network with only unlabeled data can be a computing resource intensive task. In contrast, the techniques described herein utilize unlabeled data as well as labelled data to identify those features that have a high contribution (or are expected to have a high contribution) to the student-teacher network's output. Unlike conventional solutions that do not have enough training data to converge in a timely (or resource efficient) manner, the techniques described herein achieve relative computation efficiencies by also providing the student-teacher network with labelled data points using an adaptive learning framework-which in turn results in the network converging relatively sooner (and in that regard, consuming fewer computing resources to achieve such convergence). This allows for less time spent training because, instead of using random initialization, training data can be initialized using the labelled data.

Additionally, using feature importance models (e.g., implemented as machine learning models) to reduce the number of features that are used to generate inputs to the student-teacher networks allows the student-teacher networks to reduce weight of the their respective networks to the core features for each digital campaign. In this manner, the computation of a likelihood that a user will respond affirmatively to a particular digital campaign in the present solution is performed with respect to a substantially reduced feature set instead of a larger population of features-without any substantive impact on the solution's overall accuracy.

The techniques described herein can be used in the context of digital campaigns for any digital platform (e.g., financial platforms, ecommerce platforms, etc.) and in particular, enable accurate selection of digital campaigns with the highest likelihood of success for transitioning a user to a particular user category. One skilled in the art will appreciate that the above described techniques can be applicable in the context of any digital platform (irrespective of type of platform).

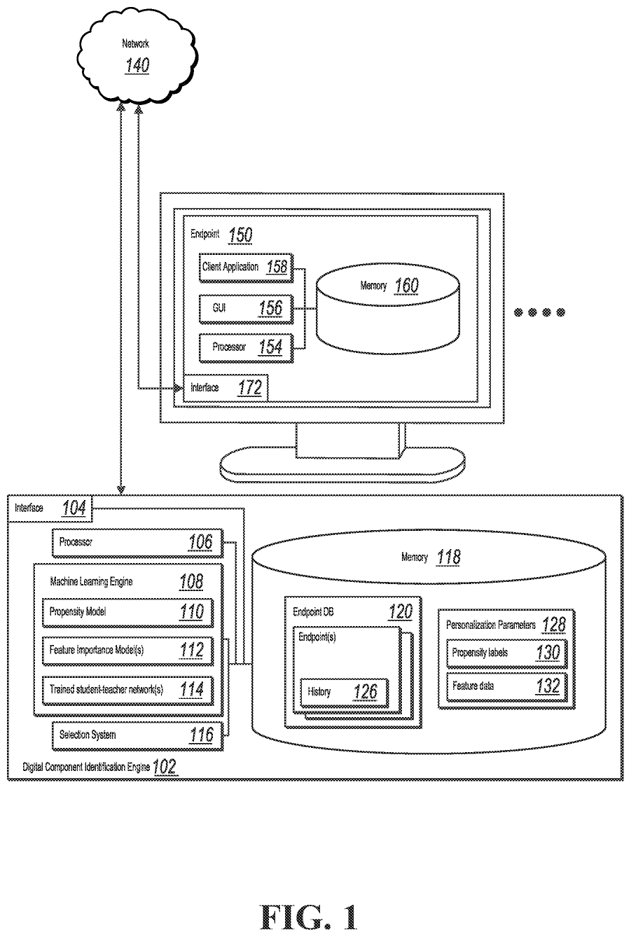

Turning to the illustrated example implementation, FIG. 1 is a block diagram illustrating an example networked environment 100 that uses a series of machine learning models to identify particular digital component (among other digital components) to provide to devices associated with one or more users of the digital platform in the networked environment. As further described with reference to FIG. 1, the environment implements various trained machine learning models that are used to in analyzing user data to select the digital component for provision to a particular user and to which the user is expected to provide/perform an affirmative action (e.g., request transition from a first user category on the platform to a second user category). As used in this specification, a digital component is a discrete unit of digital content or digital information such as, e.g., a video clip, an audio clip, a multimedia clip, an image, text, a uniform resource locator (URL), or another unit of content.

As shown in FIG. 1, the example environment 100 includes a digital component identification engine 102 and multiple endpoints 150 that are interconnected over a network 140. The function and operation of each of these components is described below.

In some implementations, the illustrated implementation is directed to techniques whereby the component identification engine 102 can identify a particular digital campaign for a particular user and thereby identify a digital component associated with that campaign that is to be transmitted to a user of a digital platform and to which the user is expected to provide/perform an affirmative action (e.g., request transition from a first user category on the platform to a second user category). The campaign selection engine 102 can compute, using a propensity model 110 included in a machine learning engine 108, whether a user is expected to transition to a particular user category on a digital platform in response to a digital campaign for one or more endpoints 150. The feature importance model 112 is a machine learning model that can identify a subset of contributing user features that are indicative of a likelihood of the user responding to the digital campaign for each of a plurality of digital campaigns based on one or more factors, such as location or other account attributes (e.g., activity on the digital platform).

As illustrated, the campaign selection engine 102 includes or is associated with a machine learning engine 108. The machine learning engine 108 may be any application, program, other component, or combination thereof that, when executed by the processor 106, enables calculation of the likelihood of a user to respond affirmatively to a particular digital campaign.

As illustrated, the machine learning engine 108 can include a propensity model 110, one or more feature importance models 112, and one or more student-teacher neural networks 114—each of which can include or specify programmable instructions for computing a likelihood for a first user to transition to a particular user category on a digital platform in response to a digital campaign, a subset of contributing features for the user that are indicative of a likelihood of the user responding to a particular digital campaign, and a likelihood that the user will respond affirmatively to the particular digital campaign, respectively. For an endpoint 150, the propensity model 110 can compute a likelihood that a user will transition to a particular user category within a particular time period (e.g., 4 months) based on features associated with the user. The one or more feature importance models 112 can then compute, for the endpoint 150 and for a particular digital campaign, a subset of features that affect the likelihood that the user will respond to the particular digital campaign. The one or more student-teacher neural networks 114 can the process the subset of contributing features to determine a likelihood that the user will respond to the particular digital campaign. Additional details about the function and structure of these models are provided throughout this specification.

As illustrated, the campaign selection engine 102 can include a selection system 116. In some implementations, upon determining the likelihood that a user will respond affirmatively to a particular digital campaign for a plurality of digital campaigns, the selection system 116 can compare the likelihoods to identify a particular best digital campaign in response to which the first user is expected to transition to the particular user category. The digital component(s) associated with the particular best digital campaign can then be transmitted, over network 140, to the endpoint 150 associated with the user.

As described above, and in general, the environment 100 enables the illustrated components to share and communicate information across devices and systems (e.g. campaign selection engine 102, endpoint 150, among others) via network 140. As described herein, the campaign selection engine 102 and/or the endpoint 150 may be cloud-based components or systems (e.g., partially or fully), while in other instances, non-cloud-based systems may be used. In some instances, non-cloud-based systems, such as on-premise systems, client-server applications, and applications running on one or more client devices, as well as combinations thereof, may use or adapt the processes described herein. Although components are shown individually, in some implementations, functionality of two or more components, systems, or servers may be provided by a single component, system, or server. Conversely, functionality that is shown or described as being performed by one component, may be performed and/or provided by two or more components, systems, or servers.

As used in the present disclosure, the term “computer” is intended to encompass any suitable processing device. For example, the campaign selection engine 102, and/or the endpoint 150 may be any computer or processing devices such as, for example, a blade server, general-purpose personal computer (PC), Mac®, workstation, UNIX-based workstation, or any other suitable device. Moreover, although FIG. 1 illustrates a single campaign selection engine 102, the campaign selection engine 102 can be implemented using a single system or more than those illustrated, as well as computers other than servers, including a server pool. In other words, the present disclosure contemplates computers other than general-purpose computers, as well as computers without conventional operating systems.

Similarly, the endpoint 150 may be any system that can request data and/or interact with the campaign selection engine 102. The endpoint 150, also referred to as client device 150, in some instances, may be a desktop system, a client terminal, or any other suitable device, including a mobile device, such as a smartphone, tablet, smartwatch, or any other mobile computing device. In general, each illustrated component may be adapted to execute any suitable operating system, including Linux, UNIX, Windows, Mac OS®, Java™, Android™, Windows Phone OS, or iOS™, among others. The endpoint 150 may include one or more merchant—or financial institution-specific applications executing on the endpoint 150, or the endpoint 150 may include one or more Web browsers or web applications that can interact with particular applications executing remotely from the endpoint 150, such as the machine learning engine 108, among others.

As illustrated, the campaign selection engine 102 includes or is associated with interface 104, processor(s) 106, machine learning engine 108, selection system 116, and memory 118. While illustrated as provided by or included in the campaign selection engine 102, parts of the illustrated components/functionality of the campaign selection engine 102 may be separate or remote from the campaign selection engine 102, or the campaign selection engine 102 may itself be distributed across the network 140.

The interface 104 of the campaign selection engine 102 is used by the campaign selection engine 102 for communicating with other systems in a distributed environment-including within the environment 100—connected to the network 140, e.g., the endpoint 150, and other systems communicably coupled to the illustrated campaign selection engine 102 and/or network 140. Generally, the interface 104 comprises logic encoded in software and/or hardware in a suitable combination and operable to communicate with the network 140 and other components. More specifically, the interface 104 can comprise software supporting one or more communication protocols associated with communications such that the network 140 and/or interface's hardware is operable to communicate physical signals within and outside of the illustrated environment 100. Still further, the interface 104 can allow the campaign selection engine 102 to communicate with the endpoint 150, and/or other portions illustrated within the campaign selection engine 102 to perform the operations described herein.

The campaign selection engine 102, as illustrated, includes one or more processors 106. Although illustrated as a single processor 106 in FIG. 1, multiple processors may be used according to particular needs, desires, or particular implementations of the environment 100. Each processor 106 may be a central processing unit (CPU), an application specific integrated circuit (ASIC), a field-programmable gate array (FPGA), or another suitable component. Generally, the processor 106 executes instructions and manipulates data to perform the operations of the campaign selection engine 102. Specifically, the processor 106 executes the algorithms and operations described in the illustrated figures, as well as the various software modules and functionality, including the functionality for sending communications to and receiving transmissions from the endpoint 150, as well as to other devices and systems. Each processor 106 may have a single or multiple core, with each core available to host and execute an individual processing thread. Further, the number of, types of, and particular processors 106 used to execute the operations described herein may be dynamically determined based on a number of requests, interactions, and operations associated with the risk assessment engine 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including, e.g., C, C++, JavaScript, Java™, Visual Basic, assembler, Perl®, any suitable version of 4GL, as well as others.

The campaign selection engine 102 can include, among other components, one or more applications, entities, programs, agents, or other software or similar components configured to perform the operations described herein.

The campaign selection engine 102 also includes memory 118, which may represent a single memory or multiple memories. The memory 118 may include any memory or database module and may take the form of volatile or non-volatile memory including, without limitation, magnetic media, optical media, random access memory (RAM), read-only memory (ROM), removable media, or any other suitable local or remote memory component. The memory 118 may store various objects or data associated with campaign selection engine 102, including any parameters, variables, algorithms, instructions, rules, constraints, or references thereto. While illustrated within the campaign selection engine 102, memory 118 or any portion thereof, including some or all of the particular illustrated components, may be located remote from the campaign selection engine 102 in some instances, including as a cloud application or repository, or as a separate cloud application or repository when the campaign selection engine 102 itself is a cloud-based system. As illustrated, memory 118 includes an endpoint database 120. The endpoint database 120 can store various data associated with endpoint(s), including each endpoint's history 126. The history 126 of an endpoint can include, among other things, previously computed digital campaigns for the particular endpoint.

Network 140 facilitates wireless or wireline communications between the components of the environment 100 (e.g., between the campaign selection engine 102 and the endpoint 150, etc.), as well as with any other local or remote computers, such as additional mobile devices, clients, servers, or other devices communicably coupled to network 140, including those not illustrated in FIG. 1. In the illustrated environment, the network 140 is depicted as a single network, but may be comprised of more than one network without departing from the scope of this disclosure, so long as at least a portion of the network 140 may facilitate communications between senders and recipients. In some instances, one or more of the illustrated components (e.g., the campaign selection engine 102, the endpoint 150, etc.) may be included within or deployed to network 140 or a portion thereof as one or more cloud-based services or operations. The network 140 may be all or a portion of an enterprise or secured network, while in another instance, at least a portion of the network 140 may represent a connection to the Internet. In some instances, a portion of the network 140 may be a virtual private network (VPN). Further, all or a portion of the network 140 can comprise either a wireline or wireless link. Example wireless links may include 802.11a/b/g/n/ac, 802.20, WiMax, LTE, and/or any other appropriate wireless link. In other words, the network 140 encompasses any internal or external network, networks, sub-network, or combination thereof operable to facilitate communications between various computing components inside and outside the illustrated environment 100. The network 140 may communicate, for example, Internet Protocol (IP) packets, Frame Relay frames, Asynchronous Transfer Mode (ATM) cells, voice, video, data, and other suitable information between network addresses. The network 140 may also include one or more local area networks (LANs), radio access networks (RANs), metropolitan area networks (MANs), wide area networks (WANs), all or a portion of the Internet, and/or any other communication system or systems at one or more locations.

As illustrated, one or more endpoints 150 may be present in the example environment 100. Although FIG. 1 illustrates a single endpoint 150, multiple endpoints may be deployed and in use according to the particular needs, desires, or particular implementations of the environment 100. Each endpoint 150 may be associated with a particular user (e.g., an employee or a customer of a financial institution), or may be accessed by multiple users, where a particular user is associated with a current session or interaction at the endpoint 150. Endpoint 150 may be a client device at which the user is linked or associated, or a client device through which the user interacts with campaign selection engine 102 and its machine learning engine 108. As illustrated, the endpoint 150 may include an interface 152 for communication (which may be operationally and/or structurally similar to interface 104), at least one processor 154 (which may be operationally and/or structurally similar to processor 106), a graphical user interface (GUI) 156, a client application 158, and a memory 160 (similar to or different from memory 118) storing information associated with the endpoint 150.

The illustrated endpoint 150 is intended to encompass any computing device such as a desktop computer, laptop/notebook computer, mobile device, smartphone, personal data assistant (PDA), tablet computing device, one or more processors within these devices, or any other suitable processing device. In general, the endpoint 150 and its components may be adapted to execute any operating system. In some instances, the endpoint 150 may be a computer that includes an input device, such as a keypad, touch screen, or other device(s) that can interact with one or more client applications, such as one or more mobile applications, including for example a web browser, a banking application, or other suitable applications, and an output device that conveys information associated with the operation of the applications and their application windows to the user of the endpoint 150. Such information may include digital data, visual information, or a GUI 156, as shown with respect to the endpoint 150. Specifically, the endpoint 150 may be any computing device operable to communicate with the campaign selection engine 102, other end point(s), and/or other components via network 140, as well as with the network 140 itself, using a wireline or wireless connection. In general, the endpoint 150 comprises an electronic computer device operable to receive, transmit, process, and store any appropriate data associated with the environment 100 of FIG. 1.

The client application 158 executing on the endpoint 150 may include any suitable application, program, mobile app, or other component. Client application 158 can interact with the campaign selection engine 102, or portions thereof, via network 140. In some instances, the client application 158 can be a web browser, where the functionality of the client application 158 can be realized using a web application or website that the user can access and interact with via the client application 158. In other instances, the client application 158 can be a remote agent, component, or a dedicated application associated with the campaign selection engine 102. In some instances, the client application 158 can interact directly or indirectly (e.g., via a proxy server or device) with the campaign selection engine 102 or portions thereof.

GUI 156 of the endpoint 150 interfaces with at least a portion of the environment 100 for any suitable purpose, including generating a visual representation of any particular client application 158 and/or the content associated with any components of the campaign selection engine 102. For example, the GUI 156 can be used to present screens and information associated with the machine learning engine 108 and interactions associated therewith. GUI 156 may also be used to view and interact with various web pages, applications, and web services located local or external to the endpoint 150. Generally, the GUI 156 provides the user with an efficient and user-friendly presentation of data provided by or communicated within the system. The GUI 156 may comprise a plurality of customizable frames or views having interactive fields, pull-down lists, and buttons operated by the user. In general, the GUI 156 is often configurable, supports a combination of tables and graphs (bar, line, pie, status dials, etc.), and is able to build real-time portals, application windows, and presentations. Therefore, the GUI 156 contemplates any suitable graphical user interface, such as a combination of a generic web browser, a web-enable application, intelligent engine, and command line interface (CLI) that processes information in the platform and efficiently presents the results to the user visually.

While portions of the elements illustrated in FIG. 1 are shown as individual components that implement the various features and functionality through various objects, methods, or other processes, the software may instead include a number of sub-components, third-party services, libraries, and such, as appropriate. Conversely, the features and functionality of various components can be combined into single components as appropriate.

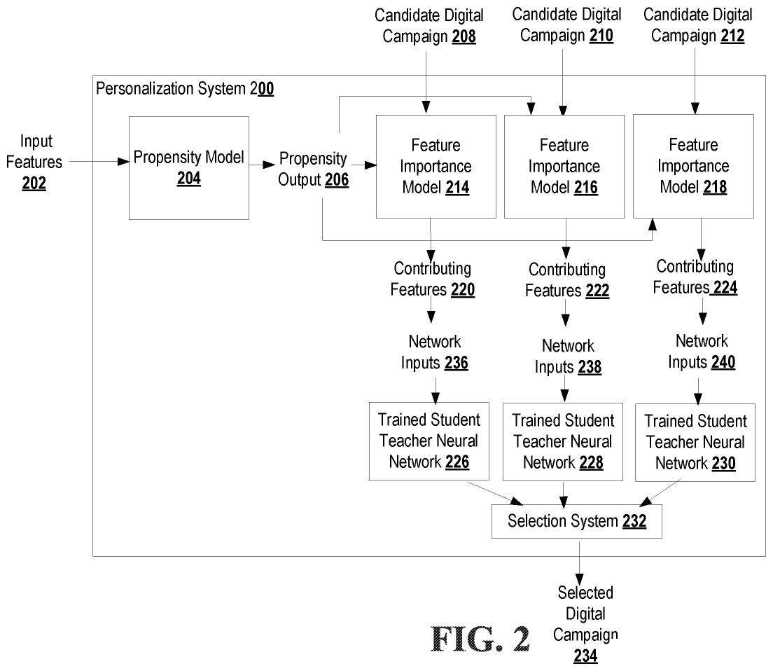

FIG. 2 shows an example campaign selection system 200 that is configured to use multiple machine learning models to identify and providing digital campaigns for a user in a networked environment, such as the networked environment 100.

As illustrated in FIG. 2, the campaign selection system 200 includes a propensity model 204, three feature importance models 214, 216, and 218, three trained student-teacher neural networks 226, 228, and 230, and a selection system 232.

The propensity model 204 processes a set of input features 202 to generate a propensity output 206. The propensity model can be any appropriate machine learning model that can be configured to process a set of features associated to generate a likelihood e.g., a gradient boosting model.

The set of input features 202 are features that can represent attributes (e.g., demographics, engagement with a digital platform, etc.) corresponding to a user. The propensity model can determine, based on the set of input features 202, the likelihood that the user will transition from a first user category to a second user category on a digital platform in response to a digital campaign. For example, the digital platform can be an investment platform and the categories can be an active investor category and a passive investor category. The propensity model can predict (based on the input features corresponding to a particular user) whether the particular user is likely to transition from active to passive or passive to active in response to a digital campaign. The digital campaign can be an email campaign or any other appropriate type of digital campaign. In some examples, the propensity output 206 can indicate that a passive user will become active in response to a digital campaign or that an active user will become passive in response to a digital campaign. The propensity output can also indicate that a user will not be influenced by a digital campaign.

The campaign selection system 200 can receive data for a plurality of candidate digital campaigns 208, 210, and 212 to transmit to a user. The data for each campaign 208, 210, and 212 in the plurality of digital campaigns can indicate one or more digital components to send to users receiving that campaign.

The campaign selection system includes a respective feature importance model 214, 216, and 218 for each candidate digital campaign 208, 210, and 212. Each feature importance model 214, 216, and 218 can process the propensity output 206 and the data for the respective candidate digital campaign 208, 210, and 212 to generate a respective subset 220, 222, and 224 of contributing features for the user that are indicative of a likelihood of the user responding to the respective digital campaign.

Each feature importance model 214, 216, and 218 identifies those features that have a high contribution (or are expected to have a high contribution) to determining a likelihood of a user responding to its respective digital campaign. In this manner, the hundreds of features of a model can be reduced to a smaller subset, e.g., of twenty features. Each feature importance model can remove similar features from its respective subset 220, 222, and 224 of contributing features and in doing so, further reduces the feature set (e.g., to a set of 9-10 features). In this manner, a student-teacher neural network 226, 228, and 230 can process a substantially reduced feature set instead of a larger population of features-without any substantive impact on the solution's overall accuracy.

Each feature importance model 214, 216, and 218 can be any appropriate type of machine learning model that can be configured to process a likelihood and set of features to generate a subset of features e.g., a gradient boosting model. For example, each feature importance model 214, 216, and 218 can be a tree-based gradient boosting model (e.g., LightGBM) to leverage explainability of such models. A tree-based gradient boosting model is based on information entropy and is non-parametric (e.g., does not require a fixed number of parameters). Additionally, there may be a lack of information regarding confounding variables and a tree-based gradient boosting model is well suited to providing results that are interpretable by a human verifier.

Each subset 220, 222, and 224 of contributing features for the user can be a subset of features that are most influential when determining if a user is likely to respond to the respective candidate digital campaign 208, 210, and 212. The feature importance models 214, 216, and 218 can disregard redundant features or features that correlate with one another for the particular digital campaign.

The campaign selection system 200 includes a respective trained student-teacher neural network 226, 228, and 230 for each candidate digital campaign 208, 210, and 212. The campaign selection system 200 processes each subset 220, 222, and 224 of contributing features to generate a set 236, 238, and 240 of respective network inputs for each trained student-teacher neural network 226, 228, and 230. Each network input in the sets 236, 238, and 240 of network inputs represents a user feature related to the respective candidate digital campaign 208, 210, and 212. The campaign selection system 200 generates the sets 236, 238, and 240 of respective network inputs by identifying a subset of features that are related to the contributing features for a particular candidate digital campaign. For example, the system 200 can select five contributing features as network inputs related to each respective candidate digital campaign 208, 210, and 212 for each trained student-teacher neural network 226, 228, and 230.

Each trained student-teacher neural network 226, 228, and 230 processes the set 236, 238, and 240 of respective network inputs to generate an output that indicates a likelihood that the user will respond affirmatively to the respective digital campaign 208, 210, and 212. For example, the likelihood can a probability (e.g., 0.6, 0.9) that a user will respond to the digital campaign.

The selection system 232 can compare the outputs from the trained student-teacher neural networks 226, 228, and 230 to identify a particular digital campaign in response to which the first user is expected to transition to the particular user category.

The selection system 232 can select the candidate digital campaign 208, 210, and 212 that has an output with the highest likelihood. In the example where the digital platform is an investment platform, the selection system 232 can identify a digital campaign for which a user is likely to respond to by transitioning from a passive state to an active state.

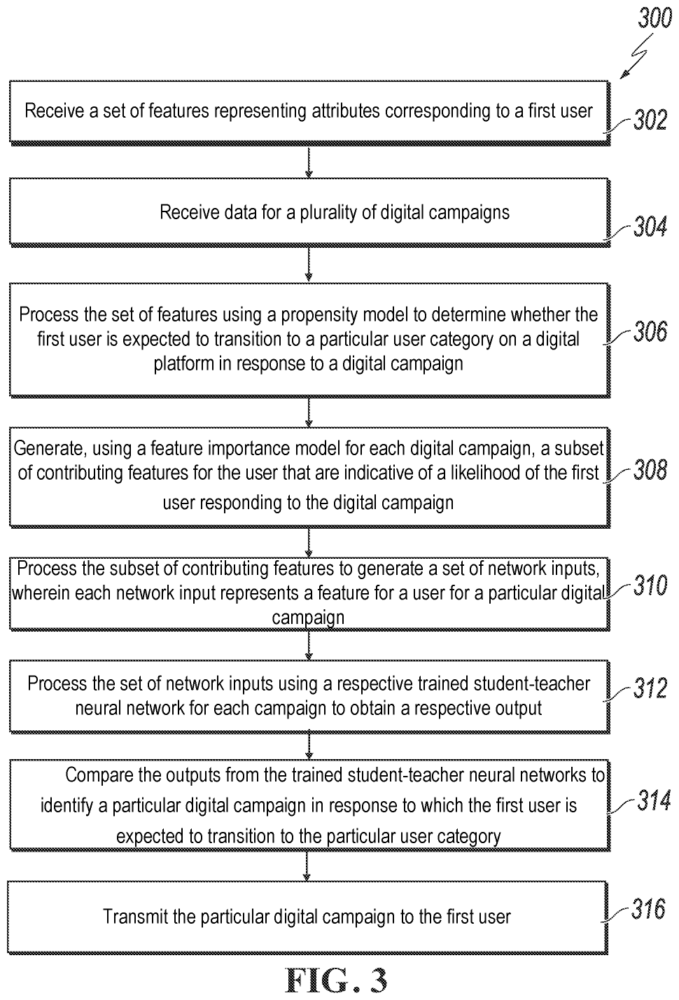

FIG. 3 is a flow diagram of an example method 300 for identifying a digital campaign for a user in a networked environment in a networked environment, such as the networked environment 100. Method 300 may be performed, for example, by any suitable system, environment, software, and hardware, or a combination of systems, environments, software, and hardware as appropriate. In some instances, method 300 can be performed by one or more components of the environment 100, including, among others, the digital component identification engine 102, or portions thereof, described in FIG. 1, as well as other components or functionality described in other portions of this description. In other instances, the method 300 can be performed by a plurality of connected components or systems, such as those illustrated in FIG. 2. Any suitable system(s), architecture(s), or application(s) can be used to perform the illustrated operations.

At 302, the digital component identification engine 102 can receive a set of features representing attributes corresponding to a first user. Example features include platform usage statistics and user demographics. The digital component identification engine can 102 utilize one or more data sources to obtain (e.g., over a network interface) features relating to the user and the particular digital platform with which the user is interacting. Examples of data collected via the data sources include, e.g., customer data and platform interaction data (which may be obtained, e.g., from usage logs of the platform and/or from data associated with the user's profile on the platform).

At 304, the digital component identification engine 102 can receive data for a plurality of digital campaigns. The digital component identification engine can 102 utilize one or more data sources to obtain (e.g., over a network interface) data relating to the plurality of digital campaigns. The data for each campaign in the plurality of digital campaigns can indicate one or more digital components to send to users receiving that campaign. The digital components can be text, images, or videos. The digital components can be sent to users via email, social media, or a digital advertisement.

At 306, the digital component identification engine 102 can process the set of features using a propensity model to determine whether the first user is expected to perform an affirmative action in response to the digital campaign. The affirmative action can include performing one or more operations to transition from a first user category to a second user category on a digital platform. In some examples, the user categories can include passive users and active users. In other examples, the user categories can include ‘basic’ customer and ‘premium’ customer.

The digital component identification engine 102 can train the propensity model using historical user data and labelled data that indicates whether a particular user has responded affirmatively to past digital campaigns (e.g., interacted with digital components associated with the campaign, adjusted user category on platform in response to received digital components associated with a digital campaign). The labelled data can also include data regarding users who did not transition from a first user category to a second user category in response to past digital campaigns.

In some examples, the propensity model can determine that a user is unlikely to transition to a particular user category on a digital platform in response to a digital campaign. In these examples, the digital component identification engine 102 will not perform steps 308-316 and will not select a campaign to transmit to the user.

At 308, the digital component identification engine 102 can generate, using a feature importance model for each digital campaign in the plurality of digital campaigns, a subset of contributing features for the user that are indicative of a likelihood of the first user performing the affirmative action in response to the digital campaign. For example, a feature importance model can find that user demographics will affect if a user will respond to the digital campaign while length of time using the digital platform does not affect if a user will respond to the digital campaign for a particular digital campaign. In some examples, the subsets of contributing features generated from each feature importance model can include different combinations of features. In other examples, the subsets of contributing features generated from each feature importance model can include the same features. In some examples, one or more subsets of contributing features can include all the features from the full set of features.

Each feature importance model can be a tree-based gradient boosting model (e.g., LightGBM) to leverage explainability. A tree-based gradient boosting model is based on information entropy and is non-parametric (e.g., does not require a fixed number of parameters). Additionally, there may be a lack of information regarding confounding variables and a tree based gradient boosting model is well suited to providing results that are interpretable by a human verifier in such scenarios.

A tree-based gradient boosting model can be used to identify contributing features that influence a model's output. Shapley values (also referred to as Shap values) also can be used to identify such contributing features; however, Shap values are based on game theory rather than information entropy and are used for parametric models—and not in tree-based gradient boosting models that are non-parametric. Moreover, using Shap values would lose the explainability advantages of a tree-based gradient boosting model. In contrast, gradient boosting models use the inherent features of the model to find contributing features since gradient boosting is an explainable model.

At 310, the digital component identification engine 102 can process the subsets of contributing features to generate a set of network inputs. Each network input can represent a user feature related to a particular digital campaign. For example, a network input can represent user demographics for a particular user. The digital component identification engine can generate the sets of respective network inputs by identifying a subset of features that are related to the contributing features for a particular candidate digital campaign.

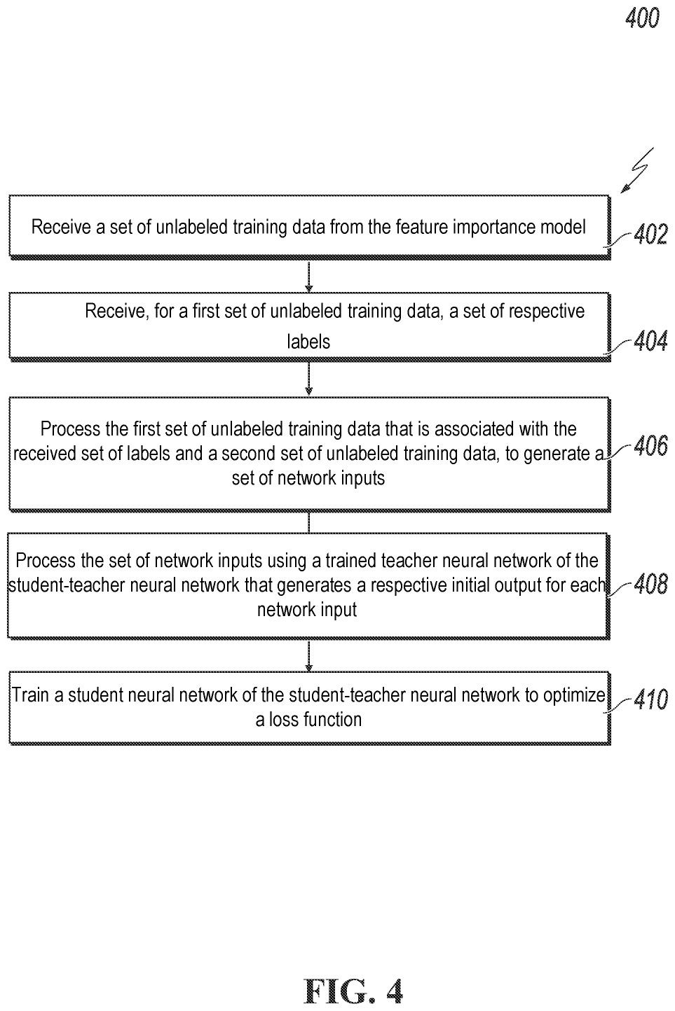

At 312, the digital component identification engine 102 can process the set of network inputs using a respective trained student-teacher neural network for each campaign in the plurality of digital campaigns, to obtain a respective output indicating a likelihood that the first user will perform an affirmative action in response to the respective digital campaign. The trained student-teacher neural networks can be trained using an active learning framework. Training the student-teacher neural networks will be described in further detail with reference to FIG. 4 below.

At 314, the digital component identification engine 102 can compare the outputs from the trained student-teacher neural networks to identify a particular digital campaign in response to which the first user has a highest likelihood of performing the affirmative action. The digital component identification engine 102 can select the campaign for which the output of the student-teacher neural network is the highest.

At 316, the digital component identification engine 102 can transmit the one or more digital components associated with a particular digital campaign to the first user.

FIG. 4 is a flow diagram of an example method 400 for training a student-teacher neural network to identifying a likelihood that a user will respond affirmatively to a digital campaign. It should be understood that method 400 may be performed, for example, by any suitable system, environment, software, and hardware, or a combination of systems, environments, software, and hardware as appropriate. Any suitable system(s), architecture(s), or application(s) can be used to perform the illustrated operations. For convenience, the process 400 will be described as being performed by a training system.

At 402, the training system receives a set of unlabeled training data from the feature importance model. The training data can include the subsets of contributing features. The training data can include historical data regarding users of the digital platform and the associated user attributes.

At 404, the training system can receive, for a first set of unlabeled training data, a set of respective labels. Each label is associated with a contributing feature for the user that is indicative of a likelihood that the first user will respond affirmatively to the respective digital campaign. The labels can be ground-truth indications that the user responded positively to the digital campaign based on the features associated with that user. The labels can be obtained from human experts or from previous experiments. The training data for each historical user can correspond to a label that indicates whether the user transitioned from a first user category to a second user category in response to a particular digital campaign.

At 406, the training system can process the first set of unlabeled training data that is associated with the received set of labels and a second set of unlabeled training data, to generate a set of network inputs. Each network input can represent a contributing feature for the user.

At 408, the training system can process the set of network inputs using a trained teacher neural network of the student-teacher neural network that generates a respective initial output for each network input. The trained teacher neural network allows the student-teacher neural network to explore inputs regarding users that the network has not seen before.

At 410, the training system trains a student neural network of the student-teacher neural network to optimize a loss function. The student neural network can process the set of network inputs and generate a respective output for each network input. In some examples, the teacher neural network and the student neural network have the same architecture. The student neural network exploits inputs regarding users that it has seen before.

Optimizing the loss function can include, for each contributing feature for the user, minimizing a loss term that measures a difference between the initial output of the teacher neural network and a proposed output of the student neural network when the set of respective labels does not include a label associated with the contributing feature. The loss term can be a mean squared error.

Optimizing the loss function can further include, for each contributing feature for the user, minimizing a loss term that measures a difference between the proposed output of the student neural network and the label associated with the contributing feature when the set of respective labels includes a label associated with the contributing feature. The loss term can be a cross entropy loss.

The loss term that measures a difference between the initial output of the teacher neural network and a proposed output of the student neural network can be represented as [symbol] ᵤ and the loss term that measures a difference between the proposed output of the student neural network and the label associated with the contributing feature can be represented as [symbol] ₛ. The loss function can be:

w [symbol] ᵤ+ [symbol] ₛ,

where w is a weight term.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving a set of features representing attributes corresponding to a first user of a digital platform;
receiving data for a plurality of digital campaigns, wherein data for each digital campaign in the plurality of digital campaigns indicates one or more digital components to send to user devices associated with users receiving that campaign;
processing the set of features using a propensity machine learning model to determine whether the first user is expected to perform an affirmative action in response to the digital campaign, wherein the affirmative action includes performing one or more operations to transition the first user from a first user category to a second user category on the digital platform;
generating, using a feature importance model for each digital campaign in the plurality of digital campaigns, a subset of contributing features for the first user that are indicative of a likelihood of the first user performing the affirmative action in response to the digital campaign;
for each digital campaign, processing the respective subset of contributing features to generate a respective set of network inputs corresponding to the digital campaign, wherein each network input represents a user feature related to a particular digital campaign;
processing each set of network inputs using a respective trained student-teacher neural network for each digital campaign in the plurality of digital campaigns, to obtain a respective output indicating a likelihood that the first user will perform an affirmative action in response to the respective digital campaign;
comparing the outputs from the trained student-teacher neural networks to identify a particular digital campaign in response to which the first user has a highest likelihood of performing the affirmative action; and
transmitting one or more digital components associated with the particular digital campaign to a user device associated with the first user.

2. The computer-implemented method of claim 1, further comprising training each student-teacher neural network model, wherein the training comprises:
receiving a set of unlabeled training data from the feature importance model;
receiving, for a first set of unlabeled training data, a set of respective labels, wherein each label is associated with a contributing feature for the user that is indicative of a likelihood that the first user will respond affirmatively to the respective digital campaign;
processing (1) the first set of unlabeled training data that is associated with the received set of labels and (2) a second set of unlabeled training data, to generate a set of network inputs, wherein each network input represents a contributing feature for the user;
processing the set of network inputs using a trained teacher neural network of the student-teacher neural network that generates a respective initial output for each network input; and
training a student neural network of the student-teacher neural network to optimize a loss function, wherein the student neural network processes the set of network inputs and generates a respective output for each network input.

3. The computer-implemented method of claim 2, wherein training a student neural network of the student-teacher neural network to optimize a loss function comprises, for each contributing feature for the user:
minimizing a loss term that measures a difference between the initial output of the teacher neural network and a proposed output of the student neural network when the set of respective labels does not include a label associated with the contributing feature; and
minimizing a loss term that measures a difference between the proposed output of the student neural network and the label associated with the contributing feature when the set of respective labels includes a label associated with the contributing feature.

4. The computer-implemented method of claim 3, wherein the loss term that measures a difference between the initial output of the teacher neural network and the proposed output of the student neural network is a mean squared error.

5. The computer implemented method of claim 3, wherein the loss term that measures a difference between the proposed output of the student neural network and the label associated with the contributing feature is a cross-entropy loss.

6. The computer-implemented method of claim 1, wherein the propensity model is a gradient boosting model.

7. The computer-implemented method of claim 1, wherein the feature importance model is a gradient boosting model.

8. The computer-implemented method of claim 2, wherein the student neural network and the teacher neural network have a same architecture.

9. The computer-implemented method of claim 1, wherein each trained student-teacher neural network is trained using an active learning technique.

10. The computer-implemented method of claim 1, wherein the subset of contributing features comprises the set of features.

11. A system comprising:
at least one memory storing instructions; and
at least one hardware processor interoperably coupled with the at least one memory, wherein execution of the instructions by the at least one hardware processor causes performance of operations comprising:
receiving a set of features representing attributes corresponding to a first user of a digital platform;
receiving data for a plurality of digital campaigns, wherein data for each digital campaign in the plurality of digital campaigns indicates one or more digital components to send to user devices associated with users receiving that campaign;
processing the set of features using a propensity machine learning model to determine whether the first user is expected to perform an affirmative action in response to the digital campaign, wherein the affirmative action includes performing one or more operations to transition the first user from a first user category to a second user category on a digital platform;
generating, using a feature importance model for each digital campaign in the plurality of digital campaigns, a subset of contributing features for the first user that are indicative of a likelihood of the first user performing the affirmative action in response to the digital campaign;
for each digital campaign, processing the respective subset of contributing features to generate a respective set of network inputs corresponding to the digital campaign, wherein each network input represents a user feature related to a particular digital campaign;
processing each set of network inputs using a respective trained student-teacher neural network for each digital campaign in the plurality of digital campaigns, to obtain a respective output indicating a likelihood that the first user will perform an affirmative action in response to the respective digital campaign;
comparing the outputs from the trained student-teacher neural networks to identify a particular digital campaign in response to which the first user has a highest likelihood of performing the affirmative action; and
transmitting one or more digital components associated with the particular digital campaign to a user device associated with the first user.

12. The system of claim 11, wherein the propensity model is a gradient boosting model.

13. The system of claim 11, wherein the feature importance model is a gradient boosting model.

14. The system of claim 11, wherein each trained student-teacher neural network is trained using an active learning technique.

15. The system of claim 11, wherein the subset of contributing features comprises the set of features.

16. A non-transitory, computer-readable medium storing computer-readable instructions, that upon execution by at least one hardware processor, cause performance of operations, comprising:
receiving a set of features representing attributes corresponding to a first user of a digital platform;
receiving data for a plurality of digital campaigns, wherein data for each digital campaign in the plurality of digital campaigns indicates one or more digital components to send to users receiving that campaign;
processing the set of features using a propensity machine learning model to determine whether the first user is expected to perform an affirmative action in response to the digital campaign, wherein the affirmative action includes performing one or more operations to transition the first user from a first user category to a second user category on the digital platform;
generating, using a feature importance model for each digital campaign in the plurality of digital campaigns, a subset of contributing features for the first user that are indicative of a likelihood of the first user performing the affirmative action in response to the digital campaign;
for each digital campaign, processing the respective subset of contributing features to generate a respective set of network inputs corresponding to the digital campaign, wherein each network input represents a user feature related to a particular digital campaign;
processing each set of network inputs using a respective trained student-teacher neural network for each digital campaign in the plurality of digital campaigns, to obtain a respective output indicating a likelihood that the first user will perform an affirmative action in response to the respective digital campaign;
comparing the outputs from the trained student-teacher neural networks to identify a particular digital campaign in response to which the first user has a highest likelihood of performing the affirmative action; and
transmitting one or more digital components associated with the particular digital campaign to a user device associated with the first user.

17. The non-transitory, computer-readable medium of claim 16, wherein the propensity model is a gradient boosting model.

18. The non-transitory, computer-readable medium of claim 16, wherein the feature importance model is a gradient boosting model.

19. The non-transitory, computer-readable medium of claim 16, wherein each trained student-teacher neural network is trained using an active learning technique.

20. The non-transitory, computer-readable medium of claim 16, wherein the subset of contributing features comprises the set of features.
